(19) United States
(12) Patent Application Publication
(10) Pub. No.: US 2004/0094867 A1
(43) Pub. Date: May 20, 2004

(54) Procedure for manufacturing a dressing for inner linings

(75) Inventors: Ramon Mirones Gomez, Burgos (ES); Anselmo Ariznavarreta, Burgos (ES)

Correspondence Address: OSTROLENK FABER GERB & SOFFEN, 1180 AVENUE OF THE AMERICAS, NEW YORK, NY, 100368403

(73) Assignee: Grupo Antolin Ingenieria S.A.

(21) Appl. No.: 10/704,511

(22) Filed: Nov. 6, 2003

(30) Foreign Application Priority Data
Nov. 7, 2002 (EP) 02380232.5

(51) Int. Cl. B32B 31/04

(52) U.S. Cl. 264/258; 264/324

(57) ABSTRACT

A process for manufacturing a dressing for an inner lining comprising molding an intermediate layer of a semi-rigid fibrous blanket, applying onto each surface of the layer a thermosetting resin and then a reinforcement layer made of fibrous material; applying at least one protective sheet on one side, covering one of the reinforcement layers defining a concealed surface; and applying onto the opposite side of the lining the decorative lining layer defining an exposed surface; and finally subjecting the layer thus obtained to a shaping or molding process in a hot press, and also polymerizing the thermosetting resin. The invention also relates to the product obtained by the process.

### BACKGROUND OF THE INVENTION

The present invention relates to a process for manufacturing a dressing for automobile interiors, particularly for automobile roofs, as well as to the dressing obtained thereby.

More specifically, the process of the invention concerns the manufacture of dressings consisting of a bedding with an intermediate layer made of a low-density material, at least one reinforcement layer attached to said intermediate layer by a resin, and a coating applied covering the reinforcement layers.

Dressings for the aforementioned purpose must have good thermal insulation properties, as well as good acoustic absorption and insulation properties. In addition, the mechanical demands on such products are constantly increasing.

In dressings obtained from beddings the layer made of a low-density material is generally of polyurethane foam or the like, and the union between the various layers is effected by a resin. Also known are dressings in which the low-density material consists of a porous fabric with fibers of different types, such as glass or polyester.

Regardless of the nature of each low-density intermediate layer, there exist alternatives for the construction of the bedding involving placing different additional layers on either surface of the intermediate layer, the different nature of these additional layers, the type of resin used, etc.

There also exist alternatives in the manufacturing process, which always end by subjecting the bedding to a shaping process in a hot press where the resins used to join the various layers undergo polymerization.

Dressings and manufacturing processes for them with the above-described features are already described in U.S. Pat. Nos. 4,828,910, 4,840,832, 6,291,370, in EP-0832787 and in ES-2157725.

In all the above cases, the adhesive used to join the various layers must be applied at the time of shaping the bedding. In addition, this adhesive fixes the shape when it polymerizes. This double function of the adhesive requires that a suitable amount be provided on the surface or surfaces of the layer of low-density material in order to impregnate it sufficiently. For this reason, the impregnation operation must take place at high temperatures and last a relatively long time.

In addition, the nature of the intermediate layer made of a low-density material can lead to handling problems when initiating the dressing manufacturing process, as it lacks stiffness in all senses.

The object of the present invention is to eliminate the above-described problems by simplifying the manufacturing process and providing a final product with improved mechanical properties, even with a smaller thickness of the bedding.

U.S. Pat. No. 4,828,910 discloses a known process.

EP-A-0 671 259 discloses a process in which a protective sheet of paper is used.

EP-A-0 285 338 discloses bonding of fibers by thermofusing.

ES-A-2 157 725 discloses the use of barrier layers.

According to the present invention, an intermediate layer is provided that consists of a semi-rigid fibrous blanket, preferably with a uniform grammage. The semi-rigid nature of the intermediate layer facilitates its handling and ensures that the grammage remains uniform throughout its surface during the entire manufacturing process of the bedding, thereby improving the final properties of the product thus obtained and simplifying the control over the manufacturing process itself.

In the process of the invention, on each surface of the aforementioned semi-rigid fibrous blanket is applied: a) a thermosetting resin, for example with a roller gluer; b) a reinforcement layer made of a fibrous material; c) a protective sheet covering at least one of the reinforcement layers, to define the concealed surface of the bedding; and d) a decorative lining on the opposite side to define the exposed surface.

The reinforcement layers can be made of fiberglass, although they can also be made of any other fibers that provide the same reinforcement function.

Before applying the layers of reinforcement material the semi-rigid fibrous blanket can be made to pass between two rollers that improve the impregnation and distribution of the resin previously applied on both surfaces.

After the resin and the reinforcement layer have been applied onto each layer of the fibrous blanket, a protective sheet is applied covering one of the reinforcement layers to define the concealed surface. This layer may be attached using the same resin used to bond the reinforcement layer, as the latter layer is permeable and the adhesive can pass through it. The protective sheet can be made of various different materials, such as paper, unwoven plant fabrics, plastic sheets, etc.

On the opposite surface the decorative lining layer is applied to determine the visible surface. Depending on the type of decorative lining used, it may be necessary in some cases to incorporate an additional barrier layer between the reinforcement layer and the decorative lining to prevent the adhesive from passing through the decorative lining and affecting its final appearance.

If no such barrier layer is placed between the decorative lining and the reinforcement layer, that lining may be attached with the same resin used for the reinforcement layer. If a barrier layer is provided, it may be formed of a thermoplastic material, so that the decorative lining can be bonded by fusing the barrier wall with a high temperature, for example in the final shaping press.

As described above, after the bedding is obtained the assembly is shaped in a hot press where the assembly is further stiffened in its final shape as the resin or thermosetting resin or resins incorporated during the shaping process of the bedding polymerize completely, thereby consolidating the interior structure by a joint action of pressure and temperature in a mold with the final shape desired for the lining.

The intermediate layer made of a low-density material consists of a wadding or blanket made of a fibrous material, preferably one with a uniform grammage, which is subjected to a process that provides a certain extent of preliminary bonding of its fibers, allowing to obtain the semi-rigid state desired. This preliminary bonding of the fibers of the center wadding can be effected in two ways: by dipping it in a bath of thermoplastic resin in liquid, molten state; or by interlinking the fibers by their rearrangement with a mechanical punching process. This preliminary bonding provides a degree of connection among the wadding fibers that allows its handling during the following stages of the process, maintaining a uniform grammage of its surface as mentioned above.

In accordance with the invention, the blanket is subjected to a subsequent bath in a thermosetting resin providing part of the stiffness and self-supporting nature that the center wadding and the dressing to be obtained will have at the end of the manufacturing process. For this purpose, after the wadding is soaked with the resin, it is subjected to a setting period in which a total or partial polymerization of the thermosetting resin takes place. If the polymerization is only partial the reaction will be later completed by the heat of the hot press used in the final shaping of the lining, thus obtaining the required final stiffness of the finished product.

All of the above-described characteristics and advantages of the invention, as well as others pertaining to the invention, will be better understood in view of the following description of an example of an embodiment made with reference to the accompanying drawings.

### BRIEF DESCRIPTION OF THE DRAWINGS

FIG. 1 shows a schematic sectional view of the composition of the bedding from which the dressing of the invention is obtained.

FIG. 2 is a schematic view of the process for manufacturing the dressing of the invention.

FIG. 3 is a manufacturing scheme, similar to that of FIG. 2, corresponding to the production of a semi-rigid fibrous blanket that forms the intermediate layer of the bedding of FIG. 1.

### DESCRIPTION OF A PREFERRED EMBODIMENT

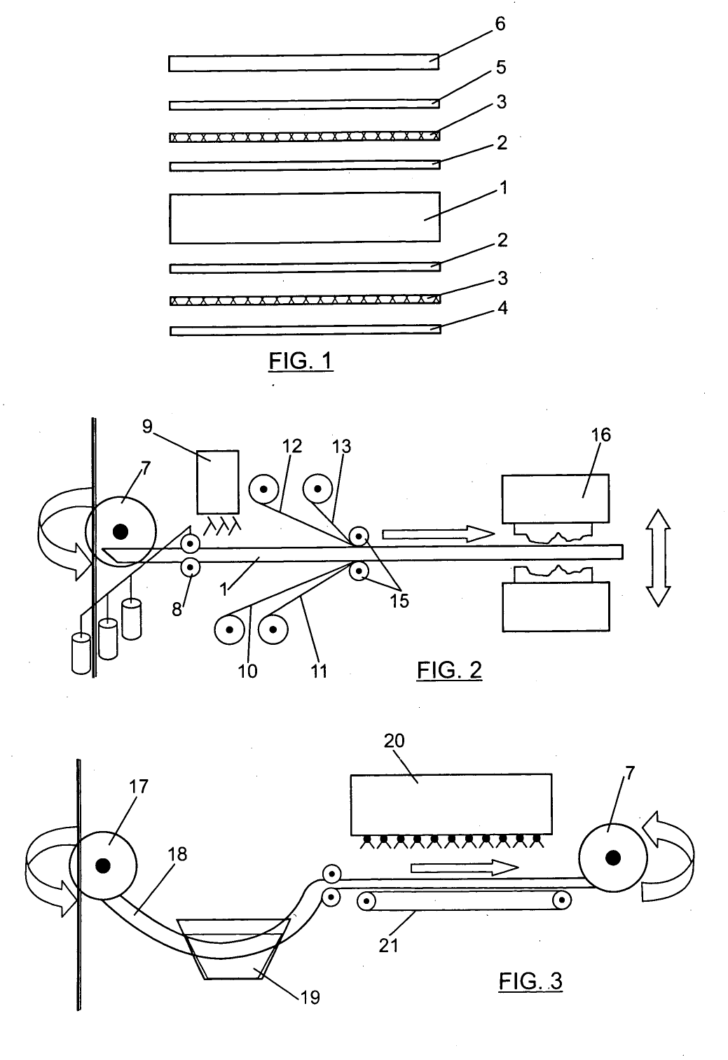

FIG. 1 shows a schematic representation of the composition of a bedding with which the dressing of the invention can be obtained.

This bedding is comprised of an intermediate layer 1 consisting of a semi-rigid fibrous blanket, a layer or coat of thermosetting resin applied on each surface of the semi-rigid fibrous blanket 1, a reinforcement layer 3 made of fibrous material applied over the layer or coating 2 of thermosetting resin, a protective sheet 4 applied over one of the reinforcement layers 3 to define the concealed surface of the lining, a barrier layer 5 on the reinforcement layer 3 on the opposite side and a decorative lining layer 6 over the barrier layer 5 to define the exposed surface.

The intermediate layer 1 can consist of a wadding of fibrous material, made with artificial fibers such as polyethylene teraphthalate, polyamide, polypropylene, vegetable fibers, etc. subjected to a punching process, and impregnated with thermoplastic resin and later with thermosetting resin. The punched fibers can be virgin or recycled fibers.

The reinforcement layer 3 can consist of glass fibers, although other fibers providing the same reinforcement function can also be used.

The barrier layer 4 can consist of a plastic sheet, an adhesive strip or a non-fabric.

The manufacturing process for the bedding of FIG. 1 is described with reference to FIG. 2.

The semi-rigid fibrous blanket used to form the bedding can have the form of a roll 7 from which the blanket is pulled out, applying the thermosetting resin layers on its surfaces with, for example, a roller gluer 8. Then the reinforcement layer 3 is applied. It is made of a fibrous material, such as with glass fibers, which can be supplied on one side as loose fibers 9, as a mat 10 or with any other arrangement or structure of the fibers. On one side the protective sheet 11 is then applied. That sheet is, for example, made of paper. It defines the exposed sheet or surface 4 of FIG. 1. A strip or sheet 12 that determines the barrier layer 5 of FIG. 1 is applied on the opposite side of the reinforcement layer. A decorative layer 13 is applied on the sheet 12 to define the exposed surface or layer 6 of FIG. 1.

The sandwich structure thus obtained can be passed between two rollers 15, for example made of rubber, that allows the resin supplied with the rollers 8 to penetrate further in the blanket 1 and better impregnate the fibers 9 with the resin.

Lastly, the bedding obtained is molded in a press 16, for example at a temperature between 120° C. and 190° C. for a molding time between 15 seconds and 180 seconds, in order to polymerize the resin, obtaining the desired shape of the dressing to be manufactured.

Next described with reference to FIG. 3 is a possible process for obtaining the fibrous semi-rigid blanket that constitutes the intermediate layer 1.

A coil 17 is used to obtain the fibrous blanket 18, which can have previously undergone a punching process. The blanket 18 is passed through a bath 19 of thermosetting resin, although it may have undergone a punching process previously. The impregnated blanket 18 can then be passed through a kiln 20 by means of the conveyor belt 21, where the resin is completely or partially polymerized to initiate the process described with reference to FIG. 2, then rewinding it to obtain the coil 7 that is used as the starting point for the process or that can be cut into plates.

If the resin is only partially polymerized in the kiln 20, the total polymerization will take place in the press 16 at the end of the process of FIG. 2, along with the resin applied at the base of the manufacturing of the bedding described with reference to FIG. 2.

In the manufacturing process for the bedding described with reference to FIG. 2, the reinforcement layer 10 can be eliminated on the side of the concealed surface. It is also possible to eliminate the barrier wall 5 of FIG. 1, depending on the type of lining 6 used. The decorative lining 13, FIG. 2, can be placed on the bedding before or after applying the rollers 15.

The glass fibers 9 used in the process of FIG. 2 can be replaced by natural fibers, such as jute, hemp, flax, sisal, etc., or applied in the form of a glass fibre blanket.

Also in the process of FIG. 2 a kiln can be employed before the press 16 and after the rollers 15 to preheat the bedding and shorten the shaping time in the press 16. With the same purpose, the rollers 15 could be heated to obtain a degree of polymerization of the bedding before it arrives at the press 16, thereby preventing the fall or detachment of the reinforcement fibers and shortening the time in the press 16.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A process for manufacturing a dressing for an inner lining and comprising the formation of a bedding, the process comprising the steps of:
providing an intermediate layer of a low density, semi-rigid fibrous blanket having opposite surfaces by providing a blanket made of the fibrous material; and subjecting the blanket to a preliminary bonding process that provides a bonding of fibers of the fibrous material, wherein;
the preliminary bonding process includes the step of impregnating the blanket with a first thermosetting resin, afterward subjecting the blanket to a setting process to cause at least a partial polymerization of the first thermosetting resin for making the blanket semi-rigid in order to facilitate handling of the blanket during following steps of the process;
applying a second thermosetting resin on the opposite surfaces of the blanket;
applying a reinforcement layer of fibrous material on at least one of the surfaces of the intermediate layer over the resin;
applying at least one protective sheet at one side of the blanket, defining a concealed surface of the bedding;
applying a decorative lining layer onto the opposite side of the blanket and defining an exposed surface of the bedding;
shaping or molding the bedding in a hot press while also polymerizing the second thermosetting resin.

2. The process of claim 1, wherein the reinforcement layers are comprised of glass fibers.

3. The process of claim 1, wherein the reinforcement layers are comprised of natural or artificial fibers.

4. The process of claim 1, wherein the protective sheet is a paper sheet.

5. The process of claim 1, wherein prior to the shaping or molding, passing the bedding between a pair of rollers operable to partially compress the bedding for causing penetration of the second thermosetting resin applied on the surfaces of the blanket to penetrate the blanket and impregnating each reinforcement layer with the second thermosetting resin.

6. The process of claim 5, wherein the rollers are heated.

7. The process of claim 1, wherein the semi-rigid fibrous blanket comprises a blanket or a padding of a fibrous material with fibers and the preliminary bonding comprises subjecting the blanket or padding to the preliminary bonding by impregnating it with a molten thermoplastic resin.

8. The process of claim 1, wherein the blanket includes thermofusing fibers.

9. The process of claim 1, wherein the preliminary bonding process comprises subjecting the fibrous material to a bonding process by mechanically punching.

10. The process of claim 7, wherein the step of impregnating the blanket with the first thermosetting resin is performed after the step of subjecting the blanket to impregnation with a molten thermoplastic resin.

11. The process of claim 9, wherein the step of impregnating the blanket with the first thermosetting resin is performed after the step of subjecting the fibers of the blanket to a mechanical punching operation.

12. The process of claim 1, further comprising applying a barrier layer of an adhesive strip or sheet between the reinforcement layer of the exposed surface side of the intermediate layer before applying the decorative lining layer.

13. The process of claim 12, wherein the barrier layer is made of a thermoplastic material, and the decorative lining layer is bonded to the bedding by fusing the barrier layer by heating.

14. The process of claim 1, wherein the decorative lining layer is adhered to the bedding by the second thermosetting resin.
